(19) United States
(12) Patent Application Publication
(10) Pub. No.: US 2006/0267245 A1
(43) Pub. Date: Nov. 30, 2006

(54) Method for Structuring the Surface of a Synthetic Fiber, Device for Carrying Out Said Method, and Fiber With All-Around Laminar Profile

(76) Inventors: Marcel Halbeisen, Buechen-Staad (CH); Helmut Schift, Gebenstorf (CH); Urs Schutz, St Gallen (CH)

Correspondence Address: COHEN, PONTANI, LIEBERMAN & PAVANE, 551 FIFTH AVENUE, SUITE 1210, NEW YORK, NY, 10176, US

(21) Appl. No.: 10/562,403

(22) PCT Filed: Jun. 16, 2004
(86) PCT No.: PCT/CH04/00364

§ 371 Date: Apr. 25, 2006

(30) Foreign Application Priority Data
Jun. 27, 2003 (CH) 1135/03

(51) Int. Cl. B29C 59/04

(52) U.S. Cl. 264/284; 264/293; 425/385

(57) ABSTRACT

In a method for structuring the surface of a synthetic fiber, a substantially cylindrical fiber (2) is provided with a predefined surface structure (38, 38a, 38b) by means of plastic deformation. A fiber (2) that is supplied in a plastically deformable state is plastically deformed in an embossing process by means of a micro-lithographically structured embossing roller (28) having a maximum structural fineness of 10 μm and is then transferred into a rigid state while the created surface structure (38, 38a, 38b) is maintained.

### TECHNICAL FIELD

The present invention relates to a method for structuring the surface of a synthetic fiber according to the preamble of claim 1, a device for carrying out said method and a fiber with all-around laminar profile.

### PRIOR ART

Several improvements in the technology of synthetic fibers are based on increasing the fiber surface. In this context, several methods are known which can be used to influence or modify the surface of synthetic fibers, filaments and/or yarns.

In a widely used method for production of synthetic fibers, fibers are produced by means of spinning nozzles provided with an appropriately shaped aperture profile. For example, spinning nozzles with a starlike aperture profile can be used in order to form a fiber with a corresponding cross sectional profile. In a further known method, the fiber is split up in longitudinal direction so as to produce so-called microfibers.

However, the above methods have the disadvantage that the profiling only occurs in the spinning or splitting direction, i.e. substantially in a longitudinal direction of the fiber; this is henceforth denoted as “longitudinal profiling” of the fiber surface. In contrast, a conditioning of the fiber surface in which the profiling runs both in longitudinal and in transversal direction of the fiber surface, henceforth denoted as “laminar profiling”, cannot be achieved. A further disadvantage of the known methods is that the fineness of the profiling is determined by the manufacturing of spinning nozzles and by the viscosity of the spinning material. Therefore, the profiling is rather coarse and comprises structures with a size of substantially more than 1 μm. Finally, although these methods lead to an increase of the fiber surface, they do not allow modifying the structure of the surface.

A method for providing a fiber with a basically arbitrary longitudinal or laminar surface profile is disclosed in U.S. Pat. No. 6,117,383. In particular, the method relates to the production of improved racket strings for tennis, badminton and squash. In this method, a substantially cylindrical, unheated plastic string is deformed plastically by the effect of pairwise cooperating embossing rollers, thus providing it with a predefined surface structure. In this method, the string material and the embossing pressure need to be selected so that a substantially irreversible plastic deformation is achieved, thus obviating the need of an after-treatment of the embossed strings. The profile depth is defined by the distance of the adjacent embossing rollers, which are shaped like a cogwheel or a cutter wheel. The distance between rollers needs to be smaller than the outer diameter of the string to be conditioned by an amount that corresponds to the desired profile depth. In this way, strings with an outer diameter of 1.0 to 1.8 mm can be provided with a surface structure consisting, for example, of a plurality of notches with a depth of about 2 to 20% of the outer diameter.

A disadvantage of the known method and the corresponding device is that the method is not suited for the conditioning of fibers with substantially smaller outer diameters of, for example, 0.1 mm or less. On the one hand—in case of a relative profile depth of 10% of the outer diameter—the distance between the embossing rollers would need to be adjusted with an accuracy of clearly better than 0.01 mm, which would not be possible with the known device. On the other hand, embossing rollers with an extremely fine embossing profile of well below 0.01 mm would have to be used in order to produce a practically useful surface structure on such a fine fiber. However, the embossing rollers shaped like a cogwheel or a cutter wheel cannot be produced with such a finely structured surface. A further disadvantage of the known method is that upon passing through a pair of embossing rollers the fiber is not provided with the desired surface structure on its entire circumference but rather on two longitudinal stripe zones. U.S. Pat. No. 6,117,383 gives no suggestions to apply the methods mentioned therein for the embossing of thin fibers such as synthetic textile fibers.

U.S. Pat. No. 4,109,356 relates to a method and a device for texturing synthetic textile material from a staple fiber band or from endless filaments by means of a mechanically applied deformation of the material. The embossing station used therein comprises a driven nonresilient heated first roller and a resilient second roller cooperating therewith. The nonresilient roller, which is made of steel or another hard material, has an elevated pattern of closely adjacent pyramids, which were formed, for example, by engraving. The resilient roller is provided with corresponding pyramid-shaped depressions. Embossing patterns consisting of up to 300 pyramids on a distance of 25.4 mm were used, i.e. the distance between single structural elements is about 85 μm.

### DESCRIPTION OF THE INVENTION

The object of the present invention is to provide an improved method for structuring the surface of a synthetic fiber and to provide a device for carrying out said method, in particular for producing fiber surfaces with a finer structure. Another object of the present invention is to provide a fiber with an all-around laminar profile.

These objects are achieved with the method defined in claim 1, the device defined in claim 6 and the fiber defined in claim 10.

According to the present invention, a method for structuring the surface of a synthetic fiber comprises providing a substantially cylindrical fiber with a predefined surface structure by means of plastic deformation. The method comprises the following steps: supplying the fiber in a plastically deformable state; plastically deforming the fiber in an embossing process by means of at least one microlithographically structured embossing roller, which cooperates with at least one pressure roller, wherein each embossing roller and each pressure roller define therebetween an embossing zone for the fiber, and wherein each embossing roller has a maximum structural fineness of 10 μm; and transferring the fiber into a rigid state while the created surface structure is maintained.

Assuming that the embossing structure comprises a plurality of structural elements in the form of elevations and depressions of the roller surface, the term “structural fineness” is defined as the width or depth of the smallest structural elements. There are various known microlithographic methods for providing a surface with an embossing structure having a fineness of 10 μm or even substantially less.

Providing the fiber in a plastically deformable state can be achieved in various ways. In particular, the fiber can be produced by a wet, melt or dry spinning process, and the fiber that is still soft from the spinning process can be directly transferred to the deformation step. Alternatively, in a melt spinning process one can start with an already rigid fiber, which can be thermally softened immediately before the deforming step. Further possibilities are based on fibers from thermally or UV-crosslinkable materials that are transformed from an initially prevailing plastically deformable state into a rigid state by means of a heat treatment or by irradiation with UV-light, thus leading to crosslinking.

Because embossing of the fiber is carried out in a plastically deformable state and the fiber is thereafter transferred to a rigid, i.e. non-deformable state, one can work with low embossing pressures. In particular, this allows using a microlithographically structured embossing roller by means of which the fiber can be provided with a very fine surface structure.

The device of the present invention comprises driving means for at least one fiber plus the following components arranged sequentially in driving direction: a device for supplying the fiber in a plastically deformable state; an embossing station; and a finishing device for transferring the fiber into a rigid state. The embossing station has at least one embossing roller provided with a microlithographically formed embossing structure and at least one pressure roller cooperating therewith, each embossing roller having a maximum structural fineness of 10 μm, and with each embossing roller and each pressure roller defining therebetween an embossing zone for the fiber. As driving means one can use well known devices with driven rollers and the like, wherein, inter alia, the embossing roller and/or the pressure roller(s) can be driven. Each embossing roller and each associated pressure roller are arranged with their mantle surfaces opposite to each other, and the embossing zone is located in a vicinity of the shortest gap between each pair of cooperating rollers. This gap is marginally smaller than the outer diameter of the fiber passed therethrough.

With the method of the present invention and the device of the present invention, a fiber with an all-around laminar profile can be produced.

Preferred embodiments of the present invention are defined in the dependent claims.

In the embodiment according to claim 2, the fiber is conducted through a plurality of embossing zones, wherein each embossing zone acts to emboss a so far unembossed part of the fiber surface. This can be achieved, for example, by an arrangement with several pressure rollers, wherein each one of the pressure rollers defines a single embossing zone together with the embossing roller. In this variant, the number of embossing zones is defined by the number of cooperating roller pairs. Alternatively, a single pair of cooperating rollers can define several embossing zones; according to claim 3, for example, the fiber is conducted around the embossing roller in screwlike fashion so as to form a plurality of windings. Thus, in the space between the single pair of cooperating rollers several embossing zones arranged beside each other are present, which are traversed in succession by the fiber due to the screwlike path. However, the embodiment according to claim 3 is also useful with an arrangement comprising several pressure rollers.

Claim 4 defines a particularly preferred embodiment, in which the embossing roller and each one of the pressure rollers cooperating therewith are driven with rotation axes inclined with respect to each other. This causes a torsion of the fiber passing therethrough, so that the fiber is twisted about a certain rotation angle around its longitudinal axis by passing a first embossing zone. In particular, one can achieve that a so far unembossed part of the fiber surface comes into contact with the embossing roller upon entry into the subsequent embossing zone. Preferably, according to claim 5, the torsion is adjusted in such a way that the fiber is embossed on its entire circumference after having passed through all of the embossing zones.

Claims 7 to 9 define particularly preferred embodiments of the device for carrying out the method mentioned above. According to claim 7, the embossing station comprises a single embossing roller and a plurality of pressure rollers that are arranged in such a way that the embossing zones are disposed substantially regularly around the circumference of the embossing roller. Alternatively, the embossing station according to claim 8 comprises a single pressure roller and a plurality of embossing rollers that are arranged in such a way that the embossing zones are disposed substantially regularly around the circumference of the pressure roller. According to claim 9, each pair consisting of a pressure roller and an embossing roller cooperating therewith are arranged at an angle with respect to each other, the respective embossing zones being located close to the minimum gap between embossing roller and pressure roller.

### BRIEF DESCRIPTION OF THE DRAWINGS

Exemplary embodiments of the invention are explained in detail hereinbelow with reference to the drawings, in which:

FIG. 1 shows a device for structuring the surface of a synthetic fiber, in perspective view;

FIG. 2 shows a section of the device of FIG. 1, in an end view;

FIG. 3 shows an enlarged section of the device of FIG. 1, in an end view;

FIG. 4 shows a section of a further device for structuring a surface, in a side view;

FIG. 5 shows the section of FIG. 4, in top view;

FIG. 6 shows a section of a further device for structuring the surface; and

FIGS. 7 to 9 show electron microscopic images of a profiled polypropylene fiber with various magnifications.

### DETAILED DESCRIPTION OF THE INVENTION

For the sake of clarity, in the figures explained hereinbelow, some of the size proportions strongly deviate from reality. In particular, the finished fibers are shown strongly enlarged in relation to the various device parts.

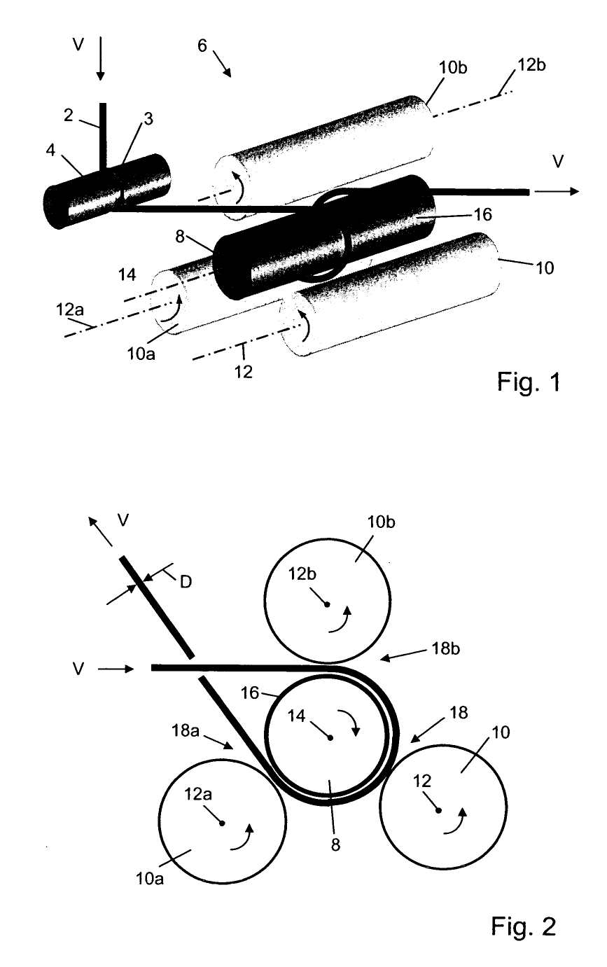

The device for structuring the surface of a synthetic fiber 2 shown in FIGS. 1 to 3 comprises a deflection roller 4 having a guidance groove 3, and an embossing station 6 with a centrally arranged embossing roller 8 and three pressure rollers 10, 10a and 10b cooperating therewith. As shown in FIGS. 1 and 2, the pressure rollers are arranged substantially starlike around the embossing roller, the longitudinal axes 12, 12a, 12b of the pressure rollers 10, 10a, 10b being oriented substantially parallel to the longitudinal axis 14 of the embossing roller 8. The fiber 2 is driven through the embossing station 6 in a driving direction V by means not shown, for example a device for driving a single one or several rollers.

In addition to the components shown, the device of FIGS. 1 to 3 further comprises: a device that is arranged prior to the embossing station and serves to prepare the fiber in a plastically deformable state; and a finishing device which is arranged behind the embossing station and serves to transfer the fiber into a rigid state.

The providing device may be, for example, a heating device for a fiber supplied thereto in a cold state. In particular, the heating device can be directly integrated in the embossing roller 8, so that the fiber 2 is transferred into a plastically deformable state by contact with the embossing roller 8, while the opposite parts of the fiber 2 cooperating with the pressure rollers are cooler and therefore are not deformable. This has the advantage that the embossing structure formed on the fiber surface is not destroyed by the pressure rollers. Alternatively, the fiber can be directly drawn from a spinning nozzle and transferred to the embossing station while still in a soft state.

As finishing device one uses a basically known cooling device. If, however, a fiber made of a thermally or UV crosslinkable material shall be embossed, the finishing device shall be a heating station or a UV irradiation station, respectively. Advantageously, irradiation occurs immediately after the embossing step, for which purpose one may use, for example, a transparent embossing roller. Furthermore, it is also possible to coat a fiber by dipping it into or spraying it with a liquid so as to form a surface that is provided with a plastically deformable precursor polymer. Moreover, it is possible to emboss a polymer fiber provided with a thin metal layer, wherein the former is structured together with the metal layer so that the metal assumes the form of the embossed polymer fiber.

The embossing roller 8 has a microlithographically formed embossing structure on its mantle surface 16. The embossing structure consists of a plurality of structural elements with the shape of elevations and depressions, wherein the height and lateral dimensions of the smallest structural elements, i.e. the so called structural fineness of the roller surface is 10 μm or even substantially less, down to 100 nm or even less. In the latter case the terms “nanolithography” or “nanolithographical”, respectively, would be more appropriate than “microlithography” or “microlithographical”, respectively, but such a distinction will not be used here for reasons of consistent terminology.

As embossing rollers one advantageously uses metal structures (nickel, steel, brass, aluminum), because these can be produced as foils and because they have sufficient mechanical stiffness and resistance against deformation. Moreover, metal rollers are very stable thermally and are compatible with most available casting tools. Furthermore, it is possible to use silicon, glass, quartz or ceramics, polymer rollers and all kinds of combined dies. For example, metal inserts in which the surface relief was formed by a thin thermally stable polymer layer have been found suitable.

For the production of embossing rollers, it is preferable to use methods by means of which copies of dies can be produced. This allows to rapidly switch to another copy in case of wear or contamination. Suitable methods for copying are galvanic molding and plastic molding.

The desired relief structures are produced by means of lithography (in particular electron beam, laser and interference lithography). The advantage of CAD controlled lithography is that a pattern defined on a computer can be transferred to a surface and then transformed into a mechanically resistant material by means of etching, galvanic or metallization processes.

The resolution of electron beam lithography is typically down to about 50 nm lateral (line widths), with details in the range down to 10 nm, with aspect ratios (=ratio of depth to height) from 1 to maximally 5. Thus, it is advantageous that an arbitrary lateral structuring is possible, i.e. one can produce, for example, acutely tapered triangles, rings, stars or line grids with various depth, but also sawtooth structures in the form of grids with a depth varying in one direction.

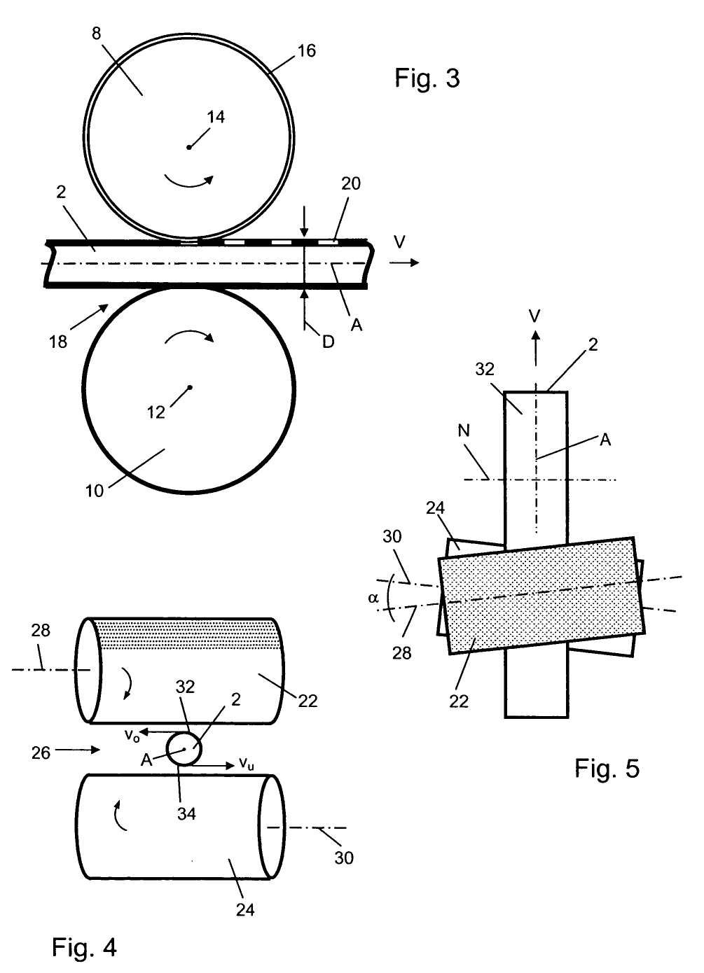

Between the embossing roller 8 and each pressure roller 10, 10a, 10b there is defined an embossing zone 18, 18a, 18b for the fiber 2. For this purpose, each pair of cooperating rollers is arranged in such a way that the gap distance between the mantle surfaces is marginally smaller than the outer diameter of the fiber passed therethrough. This is apparent particularly in FIG. 3, in which, however, the fiber diameter D is shown strongly exaggerated. Upon passing through the embossing zone 18, the embossing structure of the mantle surface 16 is pressed into the fiber 2 and causes a plastic deformation thereof. Thus the fiber 2 is provided with a surface structure 20 which essentially represents the negative of the embossing structure. An elevation of the embossing structure thus leads to a depression in the surface structure 20 of the fiber 2, whereas vice versa a depression in the embossing structure leads to an elevation on the surface structure 20 of the fiber 2. The surface structure 20 thus formed, henceforth also denoted as “microstructure”, is retained because of the subsequent transfer into a rigid state of the fiber material.

The driving speed for the fiber 2 is, for example, about 0.1 to 1 m/s. However, higher driving speeds of up to about 10 m/s or more are possible.

As further shown in FIG. 3, a single passage of the fiber 2 through a single embossing zone 18 allows applying the microstructure 20 in a striplike zone of the fiber surface. A structure extending across the entire circumference of the fiber surface can be produced by an embossing station with several consecutively arranged embossing zones, wherein each single embossing zone acts on a yet unembossed part of the fiber surface. In principle, an embossing station with several embossing rollers could be used, wherein each one acts on another sector of the fiber surface. Advantageously, however, a device with a single embossing roller as shown in FIGS. 4 to 6 is used.

As shown in FIGS. 4 and 5, the device comprises an embossing roller 22 and a pressure roller 24 arranged beneath, defining therebetween an embossing zone 26 for the fiber 2. The two rollers are arranged at an angle α with respect to each other, i.e. the longitudinal axis 28 of the embossing roller 22 and the longitudinal axis 30 of the pressure roller 24 are inclined with respect to each other. As shown in FIG. 5, the two longitudinal axes 28 and 30 diverge in opposite directions from the normal N to the longitudinal axis A of fiber 2.

Upon passing through the embossing zone 26 the fiber 2 experiences at its upper side 32 a drive defined by the rotation of the embossing roller 22, whereas the lower side 34 experiences a drive defined by the pressure roller 24. Because of the mutually inclined rotation axes, the two drive vectors have opposite lateral components, i.e. at the upper side of fiber 32 there is an upper lateral component V_{O}, while at the lower side of the fiber 34 there is a lower lateral component V_{U}. This leads to a torsion of the fiber 2, which is counterclockwise in FIG. 4.

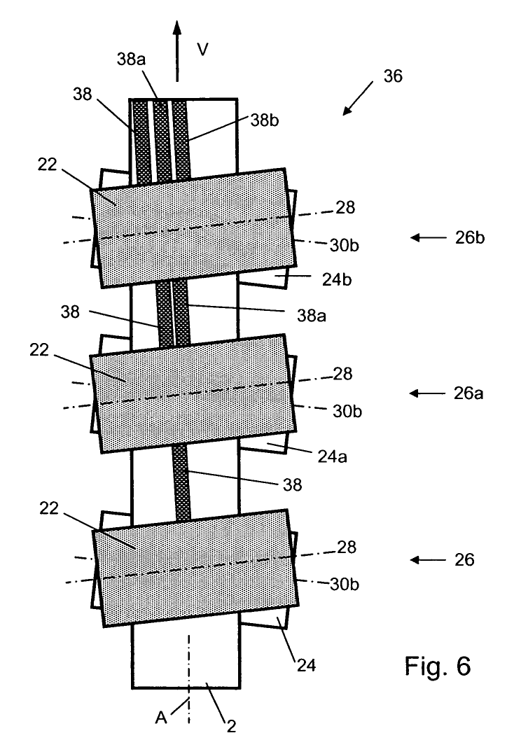

The torsion effect shown in FIGS. 4 and 5 can be exploited to the effect that upon passing an embossing station with several embossing zones the fiber always contacts the embossing roller with a still unembossed part of the fiber surface. This is shown in FIG. 6, which includes an embossing station 36 with three sequentially arranged embossing zones 26, 26a and 26b. The embossing station 36 is shown here in an unwound representation, i.e. there is one single embossing roller 22 around which are arranged three associated pressure rollers 24, 24a and 24b in starlike fashion. Therefore, the embossing station 36 is equivalent to that in FIG. 1 except for the arrangement of the rollers at an angle with respect to each other.

The fiber 2 firstly enters into the first embossing zone 26 where it is provided with a first microstructured stripe 38. Due to the torsion movement, this first stripe is displaced in counterclockwise direction from the upper edge of the fiber. In the following passage through the second embossing zone 26a a second microstructured stripe 38a is formed and simultaneously a further torsion of the fiber and thus also of the first stripe 38 is caused. For this reason, the second stripe 38a is formed beside the first stripe 38. In the same way, in the third embossing zone 26b a third microstructured stripe 38b is formed, which is formed beside the second stripe 38a due to still further torsion.

Depending on the inclination angle a and the friction between the rollers and the fiber, the passage through an embossing zone causes a torsion of different magnitude. In particular, this allows adjustment in such a way that the various microstructured stripes are formed directly adjacent to each other, optionally even partially overlapping each other.

As further shown in FIG. 6, microstructuring of the fiber on its entire circumference can be achieved by passing through a sufficient number of embossing zones. Advantageously, this is not achieved by a correspondingly larger number of pressure rollers, but rather by arranging the fiber 2 in a screwlike fashion with several windings around the embossing roller, as shown in FIG. 1 for a single winding. For example, with three pressure rollers and three windings around the embossing roller a number of nine embossing passages can be achieved. A practical limitation of this principle arises from the fact that with an arrangement of the rollers at an inclination angle the embossing zones which are defined between two rollers have to be near the shortest gap between embossing roller and pressure roller, i.e. only a central range of the respective rollers can be used for the embossing process; this range becomes correspondingly narrower with increasing inclination angle α.

Alternatively to the above described method with pairs of rollers at an inclination angle, an embossing all-around the fiber can also be achieved by twisting the fiber in the gap between two embossing zones by means of a separate torsion device, for example, by a pair of rollers arranged parallel to the longitudinal axis of the fiber.

Instead of the above described devices with a single embossing roller, it is also possible to have several embossing rollers. In particular, by analogy to the arrangement of FIGS. 1 and 2 a central pressure roller can be present instead of the central embossing roller 8, and an arrangement of three embossing rollers cooperating with the central pressure roller can be used instead of the three pressure rollers 10, 10a and 10b.

### EXAMPLE

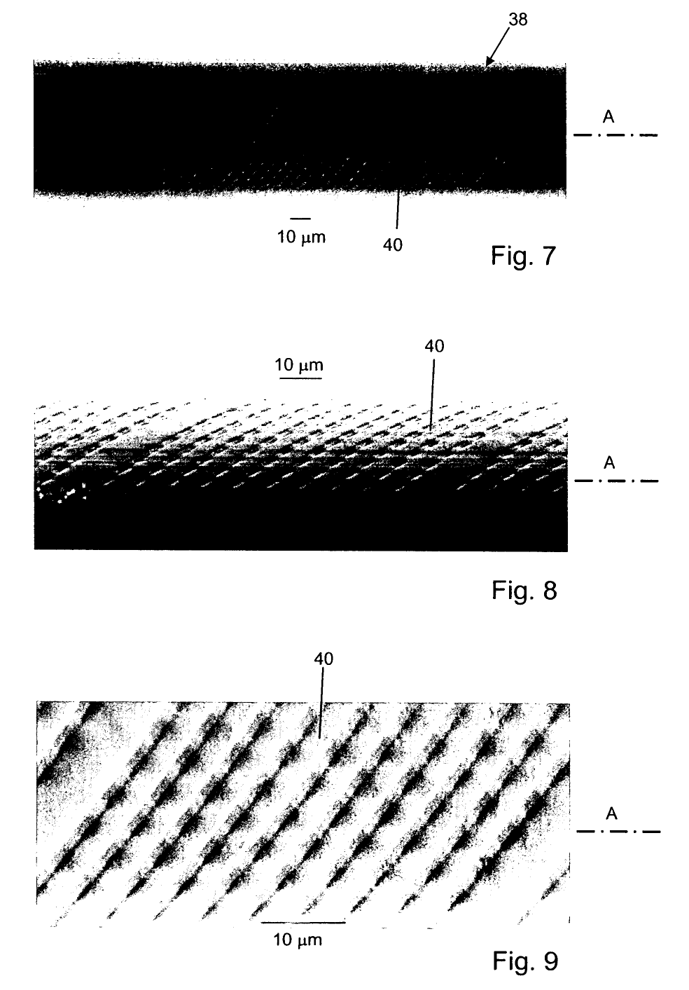

A non-profiled fiber with a diameter of 100 μm was subjected to single embossing passage by means of a microlithographically embossed cylindrical embossing roller with an outer diameter of 5 cm and a pressure roller cooperating therewith. The product thus formed is shown in FIGS. 7 to 9. The fiber with longitudinal axis A comprises a spirally circulating microstructured stripe 38 that comprises a plurality of depressions 40 with a fineness of about 1.5 μm.

Advantages and Applications

The fibers produced with the above described method provide the following advantages and applications.

Absorption and Adherence of Humidity

As a result, textiles can be developed which can absorb a large amount of humidity on the surface but nonetheless can dry very rapidly.

Absorption of Humidity and Evaporative Cooling

By sweat absorbtion and subsequent evaporation, fibers can be used for active cooling (sport textiles). The larger the fiber surface, the stronger the cooling effect.

Adherence of Finishings or Coatings

Many fibers have a very poor adherence and therefore are unsuitable or hardly suitable for finishings or coatings. By means of laminar microstructuring, fibers can be provided with a finishing or coating which would not adhere or only hardly adhere on non-structured fibers.

Synthetic Fibers Suitable for Felting

The production of fiber fleece is very laborious. By means of a sawtooth structure on the fiber, production of fleece can be achieved with methods similar to those used for production of felt with wool.

Improvement of Spinnability (production of thread)

Fiber-fiber adhesion is an important factor for spinnability. Fibers which do not adhere or only poorly adhere to each other cannot be spun together or only with insufficient fineness. By means of a laminar microstructuring, it is possible, firstly, to spin fibers that so far were not spinnable, and, secondly, substantially finer spinning threads can be produced than so far.

Adherence of Cells (medical application)

The growth of cells on laminarly microstructured fibers is easier to achieve and can be better controlled, for example in respect to the growth direction.

Fiber Composites

As a result of the enhanced fiber adherence, fiber composites that are considerably more stable can be produced than in the past.

Optical Effects

By applying on an actually transparent fiber a periodic embossing pattern, in which the distance between repeating features is smaller than the wavelength of the light, color filter effects occur due to light diffraction. At longer distances, the rainbow colors become apparent.

Light Collection Fibers

Usually, light that impinges on a fiber of transparent material is almost completely transmitted. However, if the fiber is provided with a periodic embossing pattern, the light can refract or diffract into the fiber. This can be used, for example, for collecting light for photovoltaic applications or for the production of fluorescence in the fiber, for example in clothing fashion.

Safety Features

Embossing patterns can be applied onto fibers, for example for marking by the manufacturer or for any other identification purposes.

List of Reference Numerals

2 fiber

3 guidance groove

4 deflection roller

6 embossing station

8 embossing roller

10, 10a, 10b pressure roller

12, 12a, 12b longitudinal axis of 10, 10a, 10b

14 longitudinal axis of 8

16 mantle surface of 8

18, 18a, 18b embossing zone

20 surface structure of 2

22 embossing roller

24, 24a, 24b pressure roller

26, 26a, 26b embossing zone

28 longitudinal axis of 22

30, 30a, 30b longitudinal axis of 24, 24a, 24b

32 upper side of fiber

34 lower side of fiber

36 embossing station

38 microstructured stripe

40 depression

A fiber longitudinal axis

D fiber diameter

N normal to A

V driving direction

V_{O} upper lateral component

V_{U} lower lateral component

1. A method for structuring the surface of a synthetic fiber, wherein a substantially cylindrical fiber is provided with a predefined surface structure by means of plastic deformation, characterized by the following steps:
a) supplying the fiber in a plastically deformable state;
b) plastically deforming the fiber in an embossing process by means of at least one microlithographically structured embossing roller, which cooperates with at least one pressure roller, wherein each embossing roller and each pressure roller define therebetween an embossing zone for the fiber, and wherein each embossing roller has a maximum structural fineness of 10 μm; and
c) transferring the fiber into a rigid state while maintaining the created surface structure.

2. The method according to claim 1, characterized in that the fiber is conducted through a plurality of embossing zones, wherein each embossing zone acts to emboss a yet unembossed part of the fiber surface.

3. The method according to claim 1, characterized in that the fiber is conducted around the embossing roller in screwlike fashion with a plurality of windings.

4. The method according to claim 1, characterized in that embossing roller and pressure roller have rotation axes inclined with respect to each other so as to cause a torsion of the fiber passing therethrough.

5. The method according to claim 4, characterized in that the torsion is adjusted in such a way that the fiber is embossed on its entire circumference after having passed all the embossing zones.

6. A device for carrying out the method of claim 1, comprising driving means for at least one fiber, and further comprising the following components, sequentially arranged in a driving direction (V):
a) a device for supplying the fiber in a plastically deformable state;
b) embossing station; and
c) a finishing device for transferring the fiber into a rigid state;
wherein the embossing station has at least one embossing roller provided with a microlithographically formed embossing structure and at least one pressure roller cooperating therewith, wherein the embossing roller has a maximum structural fineness of 10 μm, wherein the embossing roller and each one of the pressure rollers define an embossing zone for the fiber arranged therebetween.

7. The device according to claim 6, characterized in that the embossing station comprises a single embossing roller and a plurality of pressure rollers, which are arranged so that the single embossing zones are disposed substantially regularly around the circumference of the embossing roller.

8. The device according to claim 6, characterized in that the embossing station comprises a single pressure roller and a plurality of embossing rollers, which are arranged so that the single embossing zones are disposed substantially regularly around the circumference of the pressure roller.

9. The device according to claim 7, characterized in that each pair consisting of pressure roller and embossing roller cooperating therewith are inclined with respect to each other, wherein the corresponding embossing zone is arranged close to the shortest gap between embossing roller and pressure roller.

10. A fiber with all-around laminarly profiled surface structure, produced by a method according to claim 1.

11. The device according to claim 8, characterized in that each pair consisting of pressure roller and embossing roller cooperating therewith are inclined with respect to each other, wherein the corresponding embossing zone is arranged close to the shortest gap between embossing roller and pressure roller.

12. The method according to claim 2, characterized in that the fiber is conducted around the embossing roller in screwlike fashion with a plurality of windings.

13. The method according to claim 2, characterized in that embossing roller and pressure roller have rotation axes inclined with respect to each other so as to cause a torsion of the fiber passing therethrough.

14. The method according to claim 3, characterized in that embossing roller and pressure roller have rotation axes inclined with respect to each other so as to cause a torsion of the fiber passing therethrough.
